(19) United States
(12) Patent Application Publication
(10) Pub. No.: US 2022/0067306 A1
(43) Pub. Date: Mar. 3, 2022

(54) SYSTEM AND METHOD FOR OBJECTIVELY DETERMINING SIMILARITIES IN ELECTRONIC COMMUNICATIONS

(71) Applicant: Ment Software Ltd., Tel Aviv (IL)

(72) Inventors: Etam BENGER, Givatayim (IL); Joab ROSENBERG, Tel Aviv (IL)

(73) Assignee: Ment Software Ltd., Tel Aviv (IL)

(21) Appl. No.: 17/108,393

(22) Filed: Dec. 1, 2020

Related U.S. Application Data
(60) Provisional application No. 63/074,128, filed on Sep. 3, 2020.

(51) Int. Cl. G06F 40/44; G06K 9/62; G06F 40/279

(52) U.S. Cl. CPC G06F 40/44; G06F 40/279; G06K 9/6215

(57) ABSTRACT

A system and method for objectively determining similarities in electronic communications. A method includes analyzing a plurality of first reference inputs to determine a plurality of first agreement scores for a first user, wherein each first reference input is made by the first user with respect to one of a plurality of electronic statements; analyzing a plurality of second reference inputs to determine a plurality of second agreement scores for a second user, wherein each second reference input is made by the second user with respect to one of the electronic statements, wherein analyzing each of the plurality of first reference inputs and the plurality of second reference inputs further includes applying a plurality of predetermined agreement rules; and generating a similarity score between the first user and the second user based on the first agreement scores, the second agreement scores, and at least one predetermined similarity rule.

### CROSS-REFERENCE TO RELATED APPLICATIONS

This application claims the benefit of U.S. Provisional Application No. 63/074,128 filed on Sep. 3, 2020, the contents of which are hereby incorporated by reference.

All of the applications referenced above are hereby incorporated by reference.

### TECHNICAL FIELD

The present disclosure relates generally to determining trends in electronic communications, and more specifically to objective rules for determining similarities in electronic communications.

### BACKGROUND

These days, technology allows users to share content rapidly and easily over the internet. Therefore, enormous amounts of data are generated, shared, and stored every day.

In large, medium, and even small organizations, the amount of data being created and stored is rapidly increases such that it becomes difficult to track. Specifically, when a communication starts in an electronic environment, it is a complex mission to track the thread as it develops. In addition to the sheer amount of data which may need to be navigated as members of an organization communicate back-and-forth, the data may include large amounts of redundant and often unorganized data. Moreover, this data may be scattered across different channels such as, for example, e-mail, different messaging services, other collaborative software, and the like.

Another challenge faced by organizations is the identification and prevention of group think among the organization's employees, managers, directors, and so on. In many cases, opinions of employees are affected by opinions of their managers, coworkers, and so on. Organizations seek to bring diverse opinions to the table in order to find new and creative solutions that might not otherwise be found by employees who are thinking alike.

There are available solutions for collecting and analyzing data. However, such solutions do not provide an efficient method allowing for overcoming the challenges noted above. In particular, existing solutions for avoiding groupthink require manual review of communications or polling of employees by a manager or supervisor. This manual process often involves subjectively evaluating if opinions are similar based on communications which may not explicitly state those opinions. As a result, this process is extremely cumbersome, and results vary drastically among different reviewers.

It would therefore be advantageous to provide a solution that would overcome these challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for objectively determining similarities in electronic communications. The method comprises: analyzing a plurality of first reference inputs to determine a plurality of first agreement scores for a first user, wherein each first reference input is made by the first user with respect to one of a plurality of electronic statements, wherein the plurality of electronic statements are included in an electronic discussion conducted via electronic communications, wherein each of the first agreement scores indicates a degree to which the first user agrees with one of the plurality of electronic statements; analyzing a plurality of second reference inputs to determine a plurality of second agreement scores for a second user, wherein each second reference input is made by the second user with respect to one of the plurality of electronic statements, wherein analyzing each of the plurality of first reference inputs and the plurality of second reference inputs further comprises applying a plurality of predetermined agreement rules defining the degree to which a reference input indicates agreement with respect to a statement, wherein each of the second agreement scores indicates a degree to which the second user agrees with one of the plurality of electronic statements; and generating a similarity score between the first user and the second user based on the plurality of first agreement scores, the plurality of second agreement scores, and at least one predetermined similarity rule.

Certain embodiments disclosed herein also include a non-transitory computer readable medium having stored thereon causing a processing circuitry to execute a process, the process comprising: analyzing a plurality of first reference inputs to determine a plurality of first agreement scores for a first user, wherein each first reference input is made by the first user with respect to one of a plurality of electronic statements, wherein the plurality of electronic statements are included in an electronic discussion conducted via electronic communications, wherein each of the first agreement scores indicates a degree to which the first user agrees with one of the plurality of electronic statements; analyzing a plurality of second reference inputs to determine a plurality of second agreement scores for a second user, wherein each second reference input is made by the second user with respect to one of the plurality of electronic statements, wherein analyzing each of the plurality of first reference inputs and the plurality of second reference inputs further comprises applying a plurality of predetermined agreement rules defining the degree to which a reference input indicates agreement with respect to a statement, wherein each of the second agreement scores indicates a degree to which the second user agrees with one of the plurality of electronic statements; and generating a similarity score between the first user and the second user based on the plurality of first agreement scores, the plurality of second agreement scores, and at least one predetermined similarity rule.

Certain embodiments disclosed herein also include a system for objectively determining similarities in electronic communications. The system comprises: a processing circuitry; and a memory, the memory containing instructions that, when executed by the processing circuitry, configure the system to: analyze a plurality of first reference inputs to determine a plurality of first agreement scores for a first user, wherein each first reference input is made by the first user with respect to one of a plurality of electronic statements, wherein the plurality of electronic statements are included in an electronic discussion conducted via electronic communications, wherein each of the first agreement scores indicates a degree to which the first user agrees with one of the plurality of electronic statements; analyze a plurality of second reference inputs to determine a plurality of second agreement scores for a second user, wherein each second reference input is made by the second user with respect to one of the plurality of electronic statements, wherein analyzing each of the plurality of first reference inputs and the plurality of second reference inputs further comprises applying a plurality of predetermined agreement rules defining the degree to which a reference input indicates agreement with respect to a statement, wherein each of the second agreement scores indicates a degree to which the second user agrees with one of the plurality of electronic statements; and generate a similarity score between the first user and the second user based on the plurality of first agreement scores, the plurality of second agreement scores, and at least one predetermined similarity rule.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a computing device according to an embodiment.

FIG. 3 is a flowchart illustrating a method for objectively determining similarities in electronic communications according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments enable objectively determining similarities of users' opinions within electronic communications. Upon receiving statements of electronic discussions, a first set of reference inputs that is input by a first user is retrieved and analyzed. A first agreement score of the first user is generated with respect to the electronic statements. A set of second reference inputs that is input by a second user is retrieved and analyzed. Based on the analysis, a second agreement score of the second user is generated with respect to the electronic statements. The first and the second agreement scores are analyzed using similarity rules. Based on the analysis, an opinion similarity score that indicates the level of similarity between an opinion of the first user and an opinion of the at least a second user is generated.

In an embodiment, the electronic communications include communications which collectively make up one or more electronic discussions between a first user and a second user. An electronic discussion is a thread that usually includes statements and reference inputs. A statement may be, but is not limited to, an answer to a question that was previously raised in the electronic discussion. A reference input may be a claim input by a user with respect to a statement, a sub-claim input with respect to a previous claim, and the like.

As described further below, each of the reference inputs may further be a supportive reference input or an opposing reference input. For instance, reference inputs B, C, and D support statement A while reference input E contrasts with statement A such that reference inputs B, C, and D are supportive with respect to statement A while reference input E is opposing with respect to statement A. As another non-limiting example, reference inputs B, C and D support statement A such that these reference inputs are supportive with respect to statement A; however, reference inputs D-1, D-2, D-3, and D-4 oppose reference input D such that reference inputs D-1 through D-4 are opposing with respect to reference input D.

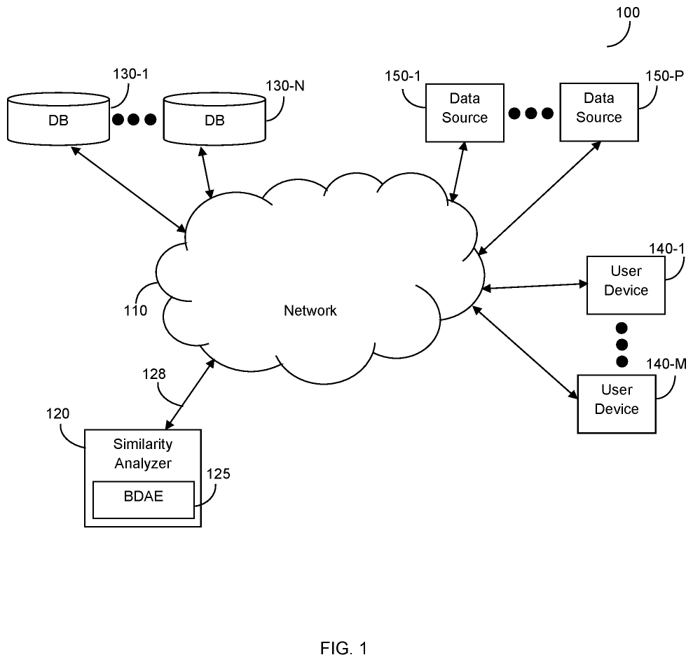

FIG. 1 shows an example network diagram 100 utilized to describe the various disclosed embodiments. In the example network diagram 100, a similarity analyzer 120, a plurality of databases 130-1 through 130-N (hereinafter referred to individually as a database 130 and collectively as databases 130, merely for simplicity purposes), and a plurality of user devices 140-1 through 140-M, and a plurality of data sources 150-1 through 150-P (hereinafter referred to individually as a data source 150 and collectively as data sources 150, merely for simplicity purposes) communicate via the network 110.

The network 110 may be, but is not limited to, a wireless, cellular or wired network, a local area network (LAN), a wide area network (WAN), a metro area network (MAN), the Internet, the worldwide web (WWW), similar networks, and any combination thereof.

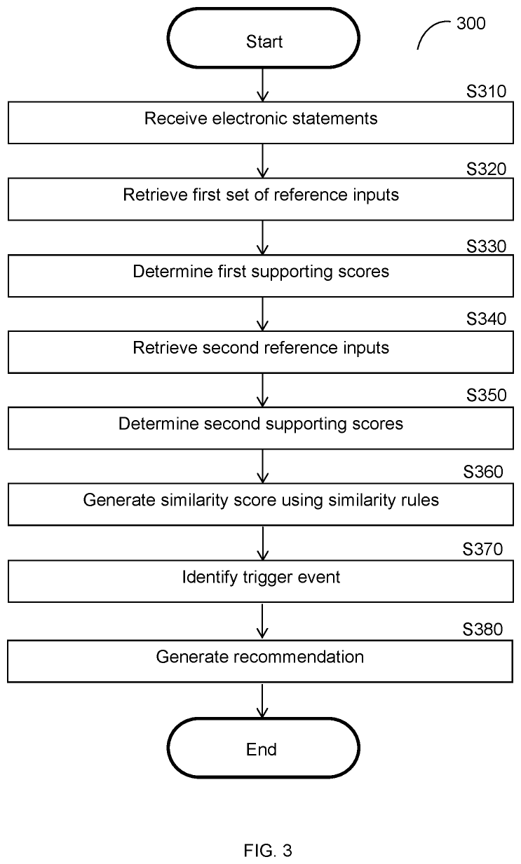

The similarity analyzer 120 is configured to perform at least a portion of the disclosed embodiments. The similarity analyzer 120 is communicatively connected, using a network interface (not shown in FIG. 1) to the network 110. In an embodiment, the similarity analyzer 120 is a combination of computer hardware and computer software components configured to execute the disclosed embodiments. An example schematic diagram illustrating example hardware components of the similarity analyzer 120 is described further below with respect to FIG. 3.

The logical components of the similarity analyzer 120 depicted in FIG. 1 include a big data analytics engine (BDAE) 125. The big data analytics engine 125 is configured to execute predetermined computing tasks related to big data analysis. The big data analytics engine 125 may use big data technologies for monitoring, extracting, and analyzing useful information from large quantities of data such as statements, reference inputs, and so on.

The databases 130 may store, for example, data and/or metadata that is associated with users, statements, reference inputs, and so on. Data and metadata that is associated with users may be, but is not limited to, a user's general and predetermined believability score, a user's knowledge level in one or more topics, a relationship between users in electronic discussions, and the like. Data and/or metadata that is associated with statements and reference inputs may include, but is not limited to, a number of reference inputs that referred to a specific statement, a type of each reference input (e.g., whether it is an opposing or a supporting reference input), a number of statements, a number and identity of users that inputted reference inputs with respect to a specific statement, and so on. In an embodiment, the database 130 may further include one or more log files that contain metadata of one or more electronic discussions. In an embodiment, the database 130 contains a set of predetermined rules (e.g., mathematical rules) that is utilized by the similarity analyzer 120 as further described herein below.

Each of the user devices 140 may be, but is not limited to, a personal computer (PC), a laptop, a smartphone, a tablet, a wearable computing device, and the like. The user device 140 is configured to send and receive data such as, but not limited to, statements (e.g., answers to questions), reference inputs (e.g., claims and sub-claims), and the like.

Each of the data sources 150 may be, but is not limited to, a website, an application, and the like, in which electronic discussions occur. In an embodiment, the similarity analyzer 120 is configured to collect or receive data and/or metadata of electronic discussions that occur in one or more of the data sources 150 and to perform at least a portion of the disclosed embodiments based on such data and/or metadata of electronic discussions.

In an embodiment, the similarity analyzer 120 receives a set of electronic statements. Each statement of the set of electronic statements is at least a portion of an electronic discussion indicated in electronic communications and may be, but is not limited to, a sentence, an answer, an image, a video, a link to a website, a combination thereof, and the like. The electronic discussion may be a thread that includes statements and one or more inputs that refer thereto. A statement may include, as a non-limiting example, an answer stating that “Oil prices will rise in the US next year.” It should be noted that statements are input into the electronic discussion by a user device, e.g., one of the user devices 140, that is associated with a particular user.

In an embodiment, the similarity analyzer 120 retrieves a set of first reference inputs related to the statements of the set of electronic statements. Each of the first reference inputs may be a supporting reference input or an opposing reference input with respect to electronic statements of the set of electronic statements that is made by another user (i.e., a user other than the first user). Each of the first reference inputs are input by a first user. As a non-limiting example, a particular user may input 1,200 reference inputs with respect to 300 statements. In a further embodiment, the first set of reference inputs includes a number of reference inputs that is above a first predetermined threshold (e.g., at minimum 1,000 reference inputs).

The reference inputs may include, but are not limited to, text, a link, an image, a video, a file, a gesture (e.g., a click or other selection made via a user interface), and the like. Each reference input may be categorized as a supporting reference input or an opposing reference input. A reference input may be categorized as a supporting reference input based on, for example, an up-vote relating to a statement, one or more reinforcing words or terms (e.g., “I agree”), a combination thereof, other indications of agreement or support, and the like. A reference input may be categorized as an opposing reference input based on, for example, a down-vote relating to a statement, one or more reinforcing words or terms (e.g., “I disagree”), a combination thereof, other indications of disagreement or disapproval, and the like.

As a non-limiting example for supporting and opposing reference inputs, a statement “A” states that “air pollution will rise all across Japan in 2030”. In that example, 10 users responded to that statement by pressing a “like” or “up-vote” button such that those 10 reference inputs are determined to support the statement “A.” According to the same example, 40 other users responded to that statement by pressing a “dislike” or “down-vote” button such that 40 reference inputs are determined to oppose the statement “A.”

In an embodiment, the similarity analyzer 120 is configured to determine a first agreement score of the first user with respect to each of the electronic statements based on the first set of reference inputs. The first agreement score may be represented by a numerical value, for example, a number between “−1” to “+1”, a number between “0” to “1”, and the like. As a non-limiting example, an agreement score of “1” with respect to a first statement indicates that the first user totally agrees with the first statement. As another non-limiting example, an agreement score of 0.8 with respect to a first statement indicates that first user partially agrees with the first statement. As yet another non-limiting example, an agreement score of “−1” with respect to a first statement indicates that the second user, to which the score is associated with, totally opposes the first statement.

A user may input more than one reference input with respect to a certain statement. Some of these reference inputs may reflect a supporting opinion and some may reflect an opposing opinion. For example, a user may input a supporting reference input with respect to a main first statement and a supporting reference input with respect to a sub-statement that opposes the first main statement.

In an embodiment, the analysis includes applying one or more predetermined agreement rules to the first reference inputs. The analysis may be achieved using one or more data and/or metadata that may be extracted from e.g., the database 130. The data and/or metadata may be indicative of the user's identity, the number of statements to which the user provided reference inputs, the type of each reference input, whether each reference input was made with respect to the first statement or with respect to a different statement which either supports or opposes the first statement, and so on. Each of the one or more predetermined agreement rules may be a mathematical rule (e.g., a formula) that, when analyzed together with the first reference inputs' data and/or metadata, facilitates determination of the first agreement score of the first user with respect to each of the electronic statements.

In an embodiment, the similarity analyzer 120 is configured to retrieve a set of second reference inputs. Each of the second reference inputs may be a second supporting reference input or a second opposing reference input with respect to the electronic statements of the set of electronic statements. The set of second reference inputs includes a number of reference inputs that is above a second predetermined threshold. The second predetermined threshold may be identical to the abovementioned first predetermined threshold. For example, the second predetermined threshold may be a minimum of 1,000 reference inputs.

As noted above, a supporting reference input may be identified by, for example, an up-vote relating to a statement and an opposing reference input may be identified by, for example, a down-vote relating to a statement. Each of the second reference inputs is input by at least a second user among one or more second users. As a non-limiting example, 5,000 second users may input multiple opposing and/or supporting reference inputs with respect to, for example, 10,000 electronic statements.

In an embodiment, the similarity analyzer 120 is configured to determine a second agreement score for each of the second users with respect to each of the electronic statements based on analysis of the second reference inputs. Each second agreement score may be represented by a number between “−1” to “+1”, “0” to “1”, and the like. In a further embodiment, the second agreement scores may be determined as described herein above with respect to the determination of the first agreement scores.

In an embodiment, the similarity analyzer 120 is configured to apply at least one predetermined similarity rule to the first and second agreement scores in order to generate one or more similarity scores. The predetermined rule may be a mathematic rule (e.g., a formula) that is utilized for determining and generating a similarity score indicating the similarity level between an opinion of the first user and an opinion of each of the second users as reflected in the reference inputs with respect to statements made by the first user in the electronic communications.

The similarity scores may be indicative of similar or dissimilar opinions of two or more users with respect to one or more topics. For example, two users (e.g., employees) from the same department having the highest similarity level score among all generated similarity scores may be identified as users that likely think the same or very similar with respect to a specific statement. As another example, two users having the lowest similarity score among all generated similarity scores may be determined as having the most dissimilar opinions with respect to that statement.

In an embodiment, the similarity analyzer 120 may be configured to generate at least one graph based on at least the generated users' opinion similarity level score of the first user and the at least a second user. The graph may include nodes representing the users and edges representing the users' opinion similarity level between the first user and the at least a second user.

In an embodiment, the similarity analyzer 120 may be configured to generate at least one recommendation based on the generated similarity scores. The recommendation may include, but is not limited to, a suggestion for changing the identity of a person (e.g., an employee) that is invited to a meeting or an electronic discussion based on the similarity level to opinions of other employees that have been invited already, adding a person to a planned meeting, and the like. The recommendation may further indicate a particular person (e.g., a user having a similarity score indicating that their opinion is dissimilar) whom should be added or substituted into a meeting or electronic communication. The particular person to be added or substituted may be based on one or more requirements for the meeting. Such requirements may include, for example, that the required person is a senior developer and that the senior developer and the chief technology officer (CTO) of the company have a similarity score that is below a threshold (i.e., the senior developer and the CTO do not think the same).

In a further embodiment, the generation of the recommendation may be achieved when a trigger event occurs. The trigger event may be, but is not limited to, a request for a meeting, scheduling of a meeting, initiating of electronic communications among users, generation of a similarity score above or below a threshold, and the like.

As a non-limiting example, two employees from the same department may plan to participate in a certain meeting. When the meeting is scheduled, the scheduling may be identified as a trigger event prompting the similarity analyzer 120 to generate a recommendation based on a similarity score between the users. Based on the similarity score, the similarity analyzer 120 determines that the employees have very similar way of thinking and, therefore, generates a recommendation to include a user having a dissimilar opinion in the meeting.

It should be noted that there may be an enormous number of statements to which multiple users may react. Therefore, using the disclosed method, the task of determining the similarity level of opinions of different users based on the enormous number of statements, becomes applicable.

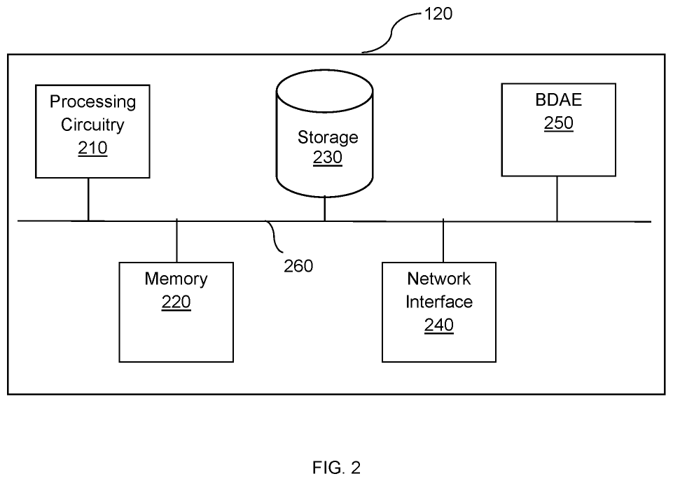

FIG. 2 is an example schematic diagram of the similarity analyzer 120 (FIG. 1), according to an embodiment. The similarity analyzer 120 includes a processing circuitry 210 coupled to a memory 220, a storage 230 and a network interface 240, and a big data analytics engine (BDAE) 250. In an embodiment, the components of the similarity analyzer 120 may be communicatively connected via a bus 260.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processing circuitry 210, cause the processing circuitry 210 to perform the various processes described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the similarity analyzer 120 to communicate with databases, data sources and other electronic devices for the purpose of, for example, retrieving data, storing data, and the like.

The big data analytics engine 250 may be a computer software component that is configured to execute predetermined computing tasks related to big data analysis. The big data analytics engine 250 may use big data technologies for monitoring, extracting, and analyzing useful information from large quantities of data, for example, statements, reference inputs, and so on.

It should be understood that the embodiments described herein are not limited to the specific architecture illustrated in FIG. 2, and that other architectures may be equally used without departing from the scope of the disclosed embodiments.

FIG. 3 is an example flowchart 300 illustrating a method for objectively determining similarities in electronic communications according to an embodiment. In an embodiment, the method may be performed by the similarity analyzer 120, FIG. 1.

At S310, a set of electronic statements is received. Each of the set of electronic statements is associated with an electronic discussion conducted via electronic communications. An electronic statement may be, but is not limited to, text (e.g., a sentence), an answer (e.g., an answer selected from a multiple choice selection such as a drop down menu or radio buttons), an image, a video, a link to a website, a combination thereof, and the like. Each electronic statement indicates an opinion of the user such that responses to the electronic statement by other users can be utilized to determine whether those other users support or oppose that opinion.

At S320, a set of first reference inputs is retrieved. In an embodiment, at least a threshold number of first reference inputs is retrieved. Each of the first reference inputs is a supporting reference input or an opposing reference input with respect to one of the electronic statements of the set of electronic statements. Each of the first reference inputs is input by a first user.

In an embodiment, S320 further includes determining whether each of the first reference inputs is a supporting reference input or an opposing reference input. In a further embodiment, such a determination may be performed using agreement rules. Such agreement rules define conditions which, when met by a given reference input, result in determining that the reference input is supporting or opposing. To this end, such rules may include, but are not limited to, determining that a reference input is supporting when the reference input is a like (e.g., the reference input represents a user pressing a “like,” “upvote,” “thumbs up,” or other such predetermined button), determining that a reference input is opposing when the reference input is a dislike (e.g., the reference input represents a user pressing a “dislike,” “downvote,” “thumbs down,” or other such predetermined button), determining that a reference input is supporting when the reference input is text including one or more predetermined supporting terms (e.g., a comment in response to a statement including terms such as “I agree,” “correct,” “right,” etc.), determining that a reference input is opposing when the reference input is text including one or more predetermined opposing terms (e.g., “disagree,” “incorrect,” “wrong,” etc.), combinations thereof, and the like.

At S330, the first reference inputs are analyzed in order to determine a first agreement score with respect to each of the electronic statements. In an embodiment, the analysis includes applying one or more predetermined rules to the first reference inputs. The analysis may be achieved using one or more data and/or metadata that may be extracted from a database (e.g., the database 130). The data and/or metadata may be indicative of the user's identity, the number of statements to which the user inputted reference inputs, the type of reference inputs, and so on. Each of the one or more predetermined rules may be a mathematical rule (e.g., a formula) that, when analyzed together with the first reference inputs' data and/or metadata, facilitates determination of a first agreement score of the first user with respect to each of the electronic statements as discussed above with respect of FIG. 1.

At S340, a set of second reference inputs is retrieved. In an embodiment, at least a threshold number of second reference inputs is retrieved. Each of the second reference inputs is at least one of a second supporting reference input or a second opposing reference input with respect to the electronic statements of the set of electronic statements. The second reference inputs are inputted by at least a second user.

At S350, the set of second reference inputs is analyzed to determine a second agreement score with respect to each of the electronic statements. In an embodiment, the analysis includes applying one or more predetermined rules to the second reference inputs. The analysis may be achieved using one or more data and/or metadata that may be extracted from a database (e.g., the database 130). The data and/or metadata may be indicative of the user's identity, the number of statements to which the user inputted reference inputs, the type of reference inputs, and so on. Each of the one or more predetermined rules may be a mathematical rule (e.g., a formula, that when analyzed together with the second reference inputs' data and/or metadata, facilitates the similarity analyzer 120 that includes the big data analytics engine 125, determining a second agreement score of the second user with respect to each of the electronic statements as discussed further above with respect of FIG. 1.

In an embodiment, S350 further includes determining whether each of the second reference inputs is a supporting reference input or an opposing reference input. In a further embodiment, such a determination may be performed using predetermined agreement rules. Such agreement rules define conditions which, when met by a given reference input, results in determining that the reference input is supporting or opposing. To this end, such rules may include, but are not limited to, determining that a reference input is supporting when the reference input is a like (e.g., the reference input represents a user pressing a “like,” “upvote,” “thumbs up,” or other such predetermined button), determining that a reference input is opposing when the reference input is a dislike (e.g., the reference input represents a user pressing a “dislike,” “downvote,” “thumbs down,” or other such predetermined button), determining that a reference input is supporting when the reference input is text including one or more predetermined supporting terms (e.g., “I agree,” “correct,” “right,” etc.), determining that a reference input is opposing when the reference input is text including one or more predetermined opposing terms (e.g., “disagree,” “incorrect,” “wrong,” etc.), combinations thereof, and the like.

At S360, a similarity score is generated based on the first and second agreement scores. In an embodiment, the similarity score is determined using one or more similarity rules. Each of the similarity rules may be a mathematic rule (e.g., a formula) that is utilized for determining and generating a similarity score indicating the level of similarity between an opinion of the first user and an opinion of the at least a second user. In an embodiment, the similarity score may be stored in a database (e.g., one of the databases 130, FIG. 1) for subsequent use (e.g., stored alongside other similarity scores and used for generating recommendations to ensure that future meetings or electronic discussions include diverse views by providing recommendations of users who have dissimilar opinions).

By utilizing predetermined rules when generating similarity scores, the disclosed embodiments provide a more objective approach to gauging similarity of opinions between users. More specifically, by analyzing reference inputs made by different users with respect to the same electronic statement using predetermined agreement rules as disclosed, it can be objectively determined whether those users either agree or disagree with respect to the content of the statement (i.e., whether they both support the statement, both oppose the statement, or one user supports while the other opposes) without subjectively evaluating the content of the statement or the responses. Further, by aggregating those agreement scores in order to generate similarity scores using the disclosed similarity rules, the overall similarity in opinion may be more objectively measured as compared to manual solutions in which a person evaluating similarity of opinions determines whether the opinions, as a whole, subjectively “feel” similar. Because the disclosed embodiments are performed differently as compared to such manual solutions, the disclosed embodiments are able to provide more consistent and accurate results as compared to those manual solutions.

At optional S370, a trigger event for generating a recommendation is identified. The trigger event relates to an electronic discussion between two or more users for which similarity scores have been generated (e.g., the electronic discussions analyzed above, a current electronic discussion between two or more users, or an upcoming electronic discussion such as a planned or scheduled meeting). The trigger event may be, but is not limited to, a request for a meeting, scheduling of a meeting, initiating of electronic communications among users, generation of a similarity score above or below a threshold, and the like.

At S380, a recommendation is generated based on one or more similarity scores when the trigger event is identified. The recommendation may include, but is not limited to, a suggestion for changing the identity of a person (e.g., an employee) that is invited to a meeting or an electronic discussion based on the similarity level to opinions of other employees that have been invited already, adding a person to a planned meeting, and the like. The recommendation may further indicate a particular person (e.g., a user having a similarity score indicating that their opinion is dissimilar) whom should be added or substituted into a meeting or electronic communication. In another embodiment, if one or more of the users participating in the electronic discussion which is the subject of the trigger event is missing a similarity score with respect to any of the other users in that electronic discussion, S380 may further include generating any such missing similarity scores.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for objectively determining similarities in electronic communications, comprising:
analyzing a plurality of first reference inputs to determine a plurality of first agreement scores for a first user, wherein each first reference input is made by the first user with respect to one of a plurality of electronic statements, wherein the plurality of electronic statements are included in an electronic discussion conducted via electronic communications, wherein each of the first agreement scores indicates a degree to which the first user agrees with one of the plurality of electronic statements;
analyzing a plurality of second reference inputs to determine a plurality of second agreement scores for a second user, wherein each second reference input is made by the second user with respect to one of the plurality of electronic statements, wherein analyzing each of the plurality of first reference inputs and the plurality of second reference inputs further comprises applying a plurality of predetermined agreement rules defining the degree to which a reference input indicates agreement with respect to a statement, wherein each of the second agreement scores indicates a degree to which the second user agrees with one of the plurality of electronic statements; and
generating a similarity score between the first user and the second user based on the plurality of first agreement scores, the plurality of second agreement scores, and at least one predetermined similarity rule.

2. The method of claim 1, wherein analyzing each of the plurality of first reference inputs and each of the plurality of second reference inputs is based further on metadata for the respective reference input, wherein the metadata for each reference input made by the first user or the second user indicates a number of electronic statements for which the respective user provided a reference input.

3. The method of claim 1, further comprising:
adding an entry to a graph, wherein the entry to the graph connects a node representing the first user to a node representing the second user and indicates the generated similarity score.

4. The method of claim 1, wherein the plurality of first reference inputs includes a number of first reference inputs above a threshold, wherein the plurality of second reference inputs includes a number of second reference inputs above the threshold.

5. The method of claim 1, wherein each of the plurality of electronic statements is any of: text, an image, a video, and a link to a website.

6. The method of claim 1, wherein the plurality of first reference inputs and the plurality of second reference inputs include at least one press of a button, wherein the plurality of agreement rules defines, for each of a plurality of predetermined buttons, whether pressing the button indicates support or opposition.

7. The method of claim 1, wherein the plurality of first reference inputs and the plurality of second reference inputs include text, wherein the plurality of agreement rules defines a plurality of portions of text indicating support and a plurality of portions of text indicating opposition.

8. The method of claim 1, wherein the electronic discussion is a first electronic discussion, further comprising:
generating a recommendation based on the similarity score, wherein the recommendation indicates that another user should be added to a second electronic discussion between the first user and the second user.

9. The method of claim 8, wherein the recommendation is generated when a trigger event is identified, wherein the trigger event is related to the second electronic discussion.

10. A non-transitory computer readable medium having stored thereon instructions for causing a processing circuitry to execute a process, the process comprising:
analyzing a plurality of first reference inputs to determine a plurality of first agreement scores for a first user, wherein each first reference input is made by the first user with respect to one of a plurality of electronic statements, wherein the plurality of electronic statements are included in an electronic discussion conducted via electronic communications, wherein each of the first agreement scores indicates a degree to which the first user agrees with one of the plurality of electronic statements;
analyzing a plurality of second reference inputs to determine a plurality of second agreement scores for a second user, wherein each second reference input is made by the second user with respect to one of the plurality of electronic statements, wherein analyzing each of the plurality of first reference inputs and the plurality of second reference inputs further comprises applying a plurality of predetermined agreement rules defining the degree to which a reference input indicates agreement with respect to a statement, wherein each of the second agreement scores indicates a degree to which the second user agrees with one of the plurality of electronic statements; and
generating a similarity score between the first user and the second user based on the plurality of first agreement scores, the plurality of second agreement scores, and at least one predetermined similarity rule.

11. A system for objectively determining similarities in electronic communications, comprising:
a processing circuitry; and
a memory, the memory containing instructions that, when executed by the processing circuitry, configure the system to:
analyze a plurality of first reference inputs to determine a plurality of first agreement scores for a first user, wherein each first reference input is made by the first user with respect to one of a plurality of electronic statements, wherein the plurality of electronic statements are included in an electronic discussion conducted via electronic communications, wherein each of the first agreement scores indicates a degree to which the first user agrees with one of the plurality of electronic statements;
analyze a plurality of second reference inputs to determine a plurality of second agreement scores for a second user, wherein each second reference input is made by the second user with respect to one of the plurality of electronic statements, wherein analyzing each of the plurality of first reference inputs and the plurality of second reference inputs further comprises applying a plurality of predetermined agreement rules defining the degree to which a reference input indicates agreement with respect to a statement, wherein each of the second agreement scores indicates a degree to which the second user agrees with one of the plurality of electronic statements; and
generate a similarity score between the first user and the second user based on the plurality of first agreement scores, the plurality of second agreement scores, and at least one predetermined similarity rule.

12. The system of claim 11, wherein analyzing each of the plurality of first reference inputs and each of the plurality of second reference inputs is based further on metadata for the respective reference input, wherein the metadata for each reference input made by the first user or the second user indicates a number of electronic statements for which the respective user provided a reference input.

13. The system of claim 11, wherein the system is further configured to:
add an entry to a graph, wherein the entry to the graph connects a node representing the first user to a node representing the second user and indicates the generated similarity score.

14. The system of claim 11, wherein the plurality of first reference inputs includes a number of first reference inputs above a threshold, wherein the plurality of second reference inputs includes a number of second reference inputs above the threshold.

15. The system of claim 11, wherein each of the plurality of electronic statements is any of: text, an image, a video, and a link to a website.

16. The system of claim 11, wherein the plurality of first reference inputs and the plurality of second reference inputs include at least one press of a button, wherein the plurality of agreement rules defines, for each of a plurality of predetermined buttons, whether pressing the button indicates support or opposition.

17. The system of claim 11, wherein the plurality of first reference inputs and the plurality of second reference inputs include text, wherein the plurality of agreement rules defines a plurality of portions of text indicating support and a plurality of portions of text indicating opposition.

18. The system of claim 11, wherein the electronic discussion is a first electronic discussion, wherein the system is further configured to:
generate a recommendation based on the similarity score, wherein the recommendation indicates that another user should be added to a second electronic discussion between the first user and the second user.

19. The system of claim 18, wherein the recommendation is generated when a trigger event is identified, wherein the trigger event is related to the second electronic discussion.
